(19) United States
(12) Patent Application Publication
(10) Pub. No.: US 2026/0311911 A1
(43) Pub. Date: Oct. 8, 2026

(54) CABLE

(71) Applicant: SUMITOMO ELECTRIC INDUSTRIES, LTD., Osaka (JP)

(72) Inventors: Taro FUJITA, Osaka (JP); Syota MACHINAKA, Osaka (JP); Yuji OCHI, Tochigi (JP); Motoi MATSUDA, Tochigi (JP); Yuto KOBAYASHI, Tochigi (JP); Atsuko SHINOMIYA, Tochigi (JP)

(73) Assignee: SUMITOMO ELECTRIC INDUSTRIES, LTD., Osaka (JP)

(21) Appl. No.: 19/481,618

(22) PCT Filed: Apr. 2, 2024
(86) PCT No.: PCT/JP2024/013619

§ 371 Date: Nov. 5, 2025

(30) Foreign Application Priority Data
Jun. 29, 2023 (JP) 2023-106957

(51) Int. Cl. H01B 11/10; H01B 3/30; H01B 7/18; H01B 7/22; H01B 11/00

(52) U.S. Cl. CPC H01B 11/1025; H01B 3/30; H01B 7/1875; H01B 7/228; H01B 11/002; H01B 11/005; H01B 11/1008

(57) ABSTRACT

A cable comprises an electric wire; and a metal layer covering the electric wire. The electric wire includes a conductor and an insulating material on an outer peripheral surface of the conductor. The insulating material contains a polyolefin resin, a phenolic antioxidant, and a copper deactivator. An amount of the polyolefin resin in the insulating material is 98 mass % or more. The insulating material contains 0.01 parts by mass to 0.5 parts by mass of the phenolic antioxidant and 0.01 parts by mass to 0.5 parts by mass of the copper deactivator relative to 100 parts by mass of the polyolefin resin, and has a dielectric loss tangent of 3.0×10⁻⁴ or less at 10 GHz. The metal layer includes a longitudinally attached metal layer formed by longitudinally attaching a metal tape forming an overlapping portion in which sections of the metal tape overlap in its width direction.

### TECHNICAL FIELD

The present disclosure relates to a cable. This application claims priority to Japanese Patent Application No. 2023-106957 filed Jun. 29, 2023, the entire contents of which are incorporated herein by reference.

### BACKGROUND ART

With the growing demand for autonomous driving technology and driver assistance functions in automobiles, the need for higher data transmission capacity and faster data transmission in automotive information electric wires is increasing. Automotive information electric wires are composed of metal conductors, such as copper, covered with an insulating material made of polyolefin resin. Transmission loss is positively correlated with the signal frequency and the dielectric loss tangent of the insulating material. Therefore, high-speed signal transmission requires reducing the dielectric loss tangent of the insulating material to further reduce transmission loss and ensure stable signal transmission.

Automotive information electric wires are typically used in automotive information transmission cables in which one or more automotive information electric wires are covered with an outer sheath to enhance mechanical protection, flame resistance, oil resistance, and other properties. Automotive information transmission cables may be used in bundles with electric wires, cables, and wire harnesses that use polyvinyl chloride (hereinafter referred to as “PVC”) for the outer sheath. In this case, antioxidants contained in the insulating material of the automotive information transmission cables may migrate into the PVC of the surrounding electric wires and other components to cause oxidative degradation of the insulating material of the automotive information transmission cables, or hydrochloric acid gas generated from the PVC of the surrounding electric wires and other components may degrade the insulating material of the automotive information transmission cables.

PTL 1 discloses a technique for suppressing the degradation of the insulating material of an automotive information transmission cable when the automotive information transmission cable is bundled with a wire harness having an insulating material made of PVC. Specifically, a large amount of antioxidant is added to the insulating material to suppress the degradation of the insulating material.

### CITATION LIST

### Patent Literature

PTL 1: Japanese Unexamined Patent Application Publication No. 2022-60751

### SUMMARY OF INVENTION

A cable according to the present disclosure comprises:
an electric wire; and a metal layer covering the electric wire,
wherein the electric wire includes a conductor and an insulating material on an outer peripheral surface of the conductor,
the insulating material contains a polyolefin resin, a phenolic antioxidant, and a copper deactivator,
an amount of the polyolefin resin in the insulating material is 98 mass % or more,
the insulating material contains 0.01 parts by mass to 0.5 parts by mass of the phenolic antioxidant and 0.01 parts by mass to 0.5 parts by mass of the copper deactivator relative to 100 parts by mass of the polyolefin resin, and has a dielectric loss tangent of 3.0×10⁻⁴ or less at 10 GHZ,
the metal layer includes a longitudinally attached metal layer formed by longitudinally attaching a metal tape,
the metal tape forms an overlapping portion in which sections of the metal tape overlap in its width direction, and
the overlapping portion has a width of 1/20 to ⅓ of a width of the metal tape.

### BRIEF DESCRIPTION OF THE DRAWINGS

FIG. 1 is a schematic cross-sectional view of a cable according to a first embodiment and a second embodiment.

FIG. 2 is a schematic cross-sectional view of a cable according to a third embodiment.

FIG. 3 is a view illustrating longitudinal attachment of a metal tape.

FIG. 4 is a view illustrating transverse winding of the metal tape.

FIG. 5A is a schematic cross-sectional view of one example of a cable according to a fourth embodiment.

FIG. 5B is a schematic cross-sectional view of another example of the cable according to the fourth embodiment.

FIG. 6A is a schematic cross-sectional view of one example of a cable according to a fifth embodiment.

FIG. 6B is a schematic cross-sectional view of another example of the cable according to the fifth Embodiment.

FIG. 7 is a schematic cross-sectional view of a cable according to a sixth embodiment.

FIG. 8 is a schematic cross-sectional view of another example of the cable according to the sixth embodiment.

FIG. 9 is a schematic cross-sectional view of a cable according to a seventh embodiment.

FIG. 10 is a schematic cross-sectional view of another example of the cable according to the seventh embodiment.

FIG. 11A is a cross-sectional view of one example of a test structure used in an insulation degradation suppression evaluation test.

FIG. 11B is a cross-sectional view of another example of the test structure used in the insulation degradation suppression evaluation test.

### DETAILED DESCRIPTION

### Problems to be Solved by Present Disclosure

Adding a large amount of antioxidant is undesirable because it increases the dielectric loss tangent of an insulating material and impairs the high-speed signal transmission.

The present disclosure is directed to a cable in which an insulating material exhibits no increase in dielectric loss tangent and the degradation of the insulating material is unlikely to occur even when the cable is used in a bundle with a wire harness having an insulating material made of PVC. As used herein, the degradation of the insulating material refers to both heat aging and degradation caused by harmful gases generated from PVC.

### Advantageous Effects of Present Disclosure

According to the present disclosure, a cable in which an insulating material exhibits no increase in dielectric loss tangent and the degradation of the insulating material is unlikely to occur even when the cable is used in a bundle with a wire harness having an insulating material made of PVC can be provided.

### Description of Embodiments of Present Disclosure

First, embodiments according to the present disclosure are listed and described.

(1) A cable according to the present disclosure comprises:
an electric wire; and a metal layer covering the electric wire,
wherein the electric wire includes a conductor and an insulating material on an outer peripheral surface of the conductor,
the insulating material contains a polyolefin resin, a phenolic antioxidant, and a copper deactivator,
an amount of the polyolefin resin in the insulating material is 98 mass % or more,
the insulating material contains 0.01 parts by mass to 0.5 parts by mass of the phenolic antioxidant and 0.01 parts by mass to 0.5 parts by mass of the copper deactivator relative to 100 parts by mass of the polyolefin resin, and has a dielectric loss tangent of 3.0×10⁻⁴ or less at 10 GHz,
the metal layer includes a longitudinally attached metal layer formed by longitudinally attaching a metal tape,
the metal tape forms an overlapping portion in which sections of the metal tape overlap in its width direction, and
the overlapping portion has a width of 1/20 to ⅓ of a width of the metal tape.

(2) A cable according to the present disclosure comprises:
an electric wire; and a metal layer covering the electric wire,
wherein the electric wire includes a conductor and an insulating material on an outer peripheral surface of the conductor,
the insulating material contains a polyolefin resin, a phenolic antioxidant, and a copper deactivator,
an amount of the polyolefin resin in the insulating material is 98 mass % or more,
the insulating material contains 0.01 parts by mass to 0.5 parts by mass of the phenolic antioxidant and 0.01 parts by mass to 0.5 parts by mass of the copper deactivator relative to 100 parts by mass of the polyolefin resin, and has a dielectric loss tangent of 3.0×10⁻⁴ or less at 10 GHZ,
the metal layer includes a transversely wound metal layer formed by transversely winding a metal tape,
the metal tape forms an overlapping portion in which sections of the metal tape overlap in its width direction,
the overlapping portion has a width of ⅕ to ½ of a width of the metal tape, and
the metal tape has a winding angle of more than 0° and 80° or less.

According to (1) and (2) above, a cable in which an insulating material exhibits no increase in dielectric loss tangent and the degradation of the insulating material is unlikely to occur even when the cable is used in a bundle with a wire harness having an insulating material made of PVC can be provided. The reason for this may be as described below.

The insulating material of the cable according to the present disclosure contains a polyolefin resin and a phenolic antioxidant. In the insulating material, the phenolic antioxidant is contained in an amount of 0.01 parts by mass to 0.5 parts by mass relative to 100 parts by mass of the polyolefin resin, and the amount of the phenolic antioxidant is small. Therefore, the insulating material exhibits no increase in dielectric loss tangent, and the oxidative degradation of the insulating material is unlikely to occur.

The metal layer in the cable according to the present disclosure further has a shielding effect that prevents hydrochloric acid gas generated from the PVC of the surrounding wire harness from entering the interior of the cable. As a result, the hydrochloric acid gas does not reach the insulating material of the cable, thereby suppressing the degradation of the insulating material.

The metal layer in the cable according to the present disclosure further has a noise shielding effect. Accordingly, the cable according to the present disclosure can reliably transmit signals.

The cable according to the present disclosure has a low dielectric loss tangent and is particularly suitable for high-speed transmission.

(3) In (1) or (2) above, the cable may include a plurality of electric wires each being the electric wire, and
the metal layer may cover each of the electric wires.

This structure can improve the noise shielding effect.

(4) In (1) or (2) above, the cable may include a first electric wire group composed of two or more electric wires, and
the metal layer may collectively cover the first electric wire group.

This structure can improve the noise shielding effect at low cost.

(5) In any one of (1) to (4) above, the cable may further include a metal braid covering a surface of the metal layer opposite a surface facing the electric wire.

This structure can improve the noise shielding effect and can increase flexibility to facilitate wiring.

(6) In any one of (1) to (5) above, the metal tape may include a metal thin layer, and
the metal thin layer may have a thickness of 0.1 μm to 20 μm.

This structure prevents or reduces damage to the metal tape and improves the flexibility of the metal tape.

(7) In any of (1) to (6) above, the polyolefin resin may be polypropylene resin.

The use of polypropylene resin can prevent or reduce an increase in the dielectric loss tangent and the dielectric constant of the insulating material and can improve the transmission characteristics of the cable.

(8) In any one of (1) to (7) above,
the cable may further comprise an outer sheath covering the metal layer,
wherein the outer sheath may contain a polyolefin resin and a metal hydroxide,
the metal hydroxide may be at least one selected from the group consisting of magnesium hydroxide and aluminum hydroxide, and
the outer sheath may contain 50 parts by mass to 200 parts by mass of the metal hydroxide relative to 100 parts by mass of the polyolefin resin.

This structure can mechanically protect the electric wire and the metal layer, can impart flame resistance, oil resistance, and other functions, and can provide a cable in which the degradation of the insulating material is unlikely to occur even when the cable is used in a bundle with a wire harness having an insulating material made of PVC.

(9) In any one of (1) to (8) above, the metal tape may include a multilayer structure in which a substrate film, an adhesive layer, and a metal thin layer are stacked in this order,
the substrate film may be composed of polyethylene terephthalate, and
the metal thin layer may contain aluminum or copper.

This structure prevents or reduces damage to the metal tape and improves the flexibility of the metal tape.

(10) In any of (1) to (8) above, the metal tape may be made of aluminum foil or copper foil.

This structure can prevent or reduce damage to the metal tape and can improve the flexibility of the metal tape at low cost.

(11) In (1) or (2) above, the cable may include two electric wires each being the electric wire, and
the two electric wires may be twisted together as a pair.

(12) In (1) or (2) above, the cable may include two electric wires each being the electric wire, and
a resin tape may be transversely wound around the two electric wires.

### Details of Embodiments of Present Disclosure

Specific examples of the cable according to the present disclosure will be described below with reference to the drawings. In the drawings of the present disclosure, the same reference numerals indicate the same or corresponding parts. The dimensional relationships, such as length, width, thickness, and depth, have been appropriately modified for clarity and simplicity in the drawings and do not necessarily reflect actual dimensional relationships.

In this description, the notation “A to B” denotes a range defined by upper and lower limits (i.e., A or more and B or less). If the unit is not specified for A and is specified only for B, the units for A and B are the same.

In the present disclosure, if one or more numerical values are listed as each of the lower and upper limits of a numerical range, a combination of any one numerical value selected from the lower limits and any one numerical value selected from the upper limits is also deemed to be disclosed. For example, if a1 or more, b1 or more, and c1 or more are listed as the lower limits, and a2 or less, b2 or less, and c2 or less are listed as the upper limits, a1 to a2, a1 to b2, a1 to c2, b1 to a2, b1 to b2, b1 to c2, c1 to a2, c1 to b2, and c1 to c2 are deemed to be disclosed.

### First Embodiment

### <Cable>

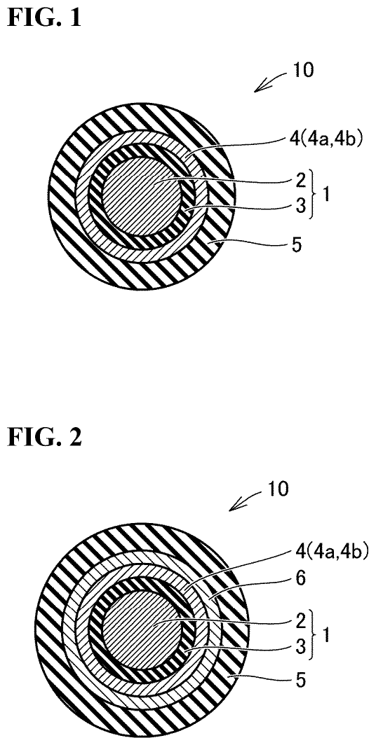

A cable according to an embodiment of the present disclosure (hereinafter also referred to as a “first embodiment”) will be described with reference to FIG. 1. FIG. 1 is a schematic cross-sectional view of a cable 10 according to the first embodiment. Referring to FIG. 1, the cable 10 according to the first embodiment includes an electric wire 1, a metal layer 4 covering the electric wire 1, and an outer sheath 5. The electric wire 1 includes one conductor 2 and an insulating material 3 on the outer peripheral surface of the conductor 2. The metal layer 4 includes a longitudinally attached metal layer 4a formed by longitudinally attaching a metal tape. The metal tape forms an overlapping portion in which sections of the metal tape overlap in its width direction, and the overlapping portion has a width of 1/20 to ⅓ of the width of the metal tape.

### (Electric Wire)

Referring to FIG. 1, in the cable 10 according to the first embodiment, the electric wire 1 includes one conductor 2 and the insulating material 3 on the outer peripheral surface of the conductor 2.

### <Conductor>

The conductor 2 is preferably composed of a metal material with high electrical conductivity and high mechanical strength. Examples of such a metal material include copper, copper alloys, aluminum, aluminum alloys, nickel, silver, soft iron, steel, and stainless steel. The conductor 2 may be a wire formed in a linear shape from a single metal material. Alternatively, the conductor 2 may be a wire covered with another metal using a technique, such as plating, to form a multilayer structure. Examples of the conductor 2 having a multilayer structure include a tin-plated copper wire, a nickel-plated copper wire, a silver-plated copper wire, a copper-plated aluminum wire, and a copper-plated steel wire.

The conductor 2 has any shape and may have a conventionally known shape. Examples of the shape of the conductor 2 include a round wire with a circular cross section, a square wire with a square cross section, a flat square wire with a rectangular cross section, and twisted wires formed by twisting a plurality of wires.

The average cross-sectional area of the conductor 2 is not limited and can be appropriately selected depending on the application. The average cross-sectional area of the conductor 2 may be 0.01 mm² to 10 mm², or may be 0.1 mm² to 10 mm². In the present disclosure, the method of measuring the average cross-sectional area of the conductor 2 is as described below. One conductor 2 is extended in a straight line, the conductor 2 is cut along a plane perpendicular to the first direction, which connects one end of the conductor 2 to the other end, to expose the cross section, and the cross-sectional area is measured. For one conductor 2, the conductor 2 is cut at any five locations along the plane perpendicular to the first direction, the cross-sectional area at each cut is measured, and the average value is calculated. This average value corresponds to the average cross-sectional area of the conductor 2.

### <Insulating Material>

In the cable 10 according to the first embodiment, the insulating material 3 is disposed on the outer peripheral surface of the conductor 2.

The insulating material 3 can contain a polyolefin resin, a phenolic antioxidant, and a copper deactivator.

### <<Polyolefin Resin>>

Examples of the polyolefin resin include polypropylene, polypropylene thermoplastic elastomer, reactor-type polypropylene thermoplastic elastomer, and dynamic cross-linked polypropylene thermoplastic elastomer; and polyethylene resins, such as polyethylene (e.g., high-density polyethylene (HDPE), linear low-density polyethylene (LLDPE), low-density polyethylene (LDPE), very-low-density polyethylene (VLDPE)), ethylene-propylene copolymer, polymethylpentene, ethylene-vinyl acetate copolymer, ethylene-ethyl acrylate copolymer, ethylene-methyl methacrylate copolymer, ethylene-methyl acrylate copolymer, ethylene-ethyl methacrylate copolymer, ethylene-butyl acrylate copolymer, ethylene-propylene rubber, ethylene acrylic rubber, ethylene-glycidyl methacrylate copolymer, and ethylene-methacrylic acid copolymer; and ionomer resins in which ethylene-methacrylic acid copolymer or ethylene-acrylic acid copolymer molecules are bonded to each other with metal ions, such as sodium or zinc ions. As the polyolefin resin, these resins modified with anhydrous maleic acid or the like and these resins having an epoxy group, an amino group, or an imide group can also be used.

“High-density polyethylene (HDPE)” refers to polyethylene having a density of 0.942 g/cm³ or more. “Linear low-density polyethylene (LLDPE)” refers to polyethylene having a density of 0.910 g/cm³ or more and less than 0.930 g/cm³ and obtained by copolymerizing ethylene and α-olefin. “Low-density polyethylene (LDPE)” refers to polyethylene having a density of 0.910 g/cm³ or more and less than 0.930 g/cm³ and obtained by polymerizing ethylene using high-pressure polymerization. “Very-low-density polyethylene (VLDPE)” refers to polyethylene having a density of 0.870 g/cm³ or more and less than 0.910 g/cm³. Examples of “polymethylpentene” includes a homopolymer of 4-methyl-1-pentene, and a copolymer of 4-methyl-1-pentene with 3-methyl-1-pentene or other α-olefins. Examples of α-olefins include propylene, butene, pentene, hexene, heptene, octene, vinyl acetate, methyl acrylate, ethyl acrylate, methyl methacrylate, and ethyl methacrylate.

Polyolefin resins may be used singly or in combination of two or more.

The polyolefin resin may be polypropylene. Examples of polypropylene include homopolypropylene, random polypropylene, and block polypropylene. Homopolypropylene is a homopolymer of propylene. Examples of random polypropylene includes copolymers of propylene with ethylene or C4-C20 α-olefins. Block polypropylene is a resin composed of homopolypropylene serving as a main component, a random copolymer elastomer serving as a copolymer component, and an ethylene polymer serving as an optional component. The use of block polypropylene or homopolypropylene among these improves mechanical strength. When the olefin resin is polypropylene, the heat resistance of the insulating material 3 and the effect of reducing the dielectric loss tangent of the insulating material 3 can be further improved. In the present disclosure, the term “main component” refers to a component with the highest content.

The lower limit of the amount of the polyolefin resin in the insulating material 3 may be 98 mass % or more, or 99 mass % or more. When the amount of the polyolefin resin is 98 mass % or more, the dielectric loss tangent of the insulating material 3 can be effectively reduced. The upper limit of the amount of the polyolefin resin may be 99.98 mass % or less, or 99.99 mass % or less. When the amount of the polyolefin resin is 99.98 mass % or less, the amount of the antioxidant and other components in the insulating material 3 can be ensured, and the insulating material 3 has better resistance to oxidative degradation and better heat resistance. The amount of the polyolefin resin in the insulating material 3 may be 98 mass % to 99.99 mass %, or 99 mass % to 99.98 mass %. When two or more polyolefin resins are used, the amount of the polyolefin resin refers to the total amount of two or more polyolefin resins.

The insulating material 3 may contain a resin other than polyolefin resins. The insulating material 3 may contain, for example, polytetrafluoroethylene, acrylic resin, fluororubber, and other substances as processing aids in a range of 0.01 mass % to 2.0 mass %.

### <<Phenolic Antioxidant>>

The phenolic antioxidant has the function of preventing the oxidation of the polyolefin resin, which is susceptible to oxidation. The inclusion of the phenolic antioxidant in the insulating material 3 can suppress the oxidative degradation of the polyolefin resin.

The phenolic antioxidant is not limited and may be any known phenolic antioxidant. Examples of the phenolic antioxidant include 3,9-bis[2-{3-(3-tert-butyl-4-hydroxy-5-methylphenyl)propionyloxy}-1,1-dimethylethyl]-2,4,8,10-tetraoxaspiro[5,5]undecane (e.g., “Sumilizer GA-80” (trademark) available from Sumitomo Chemical Co., Ltd., “ADK STAB AO-80” (trademark) available from ADEKA Corporation), ethylene bis(oxyethylene) bis[3-(5-tert-butyl-hydroxy-m-tolyl)propionate] (“IRGANOX 245” (trademark) available from BASF Japan Ltd.), triethylene glycol bis[3-(3-tert-butyl-4-hydroxy-5-methylphenyl) propionate] (e.g., “ADK STAB AO-70” (trademark) available from ADEKA Corporation), 1,3,5-tri(3,5-di-tert-butyl-4-hydroxybenzyl)-1,3,5-triazine-2,4,6(1H,3H,5H)-trione] (e.g., “ADK STAB AO-60” (trademark) available from ADEKA Corporation), 4,4′-thiobis(6-tert-butyl-m-cresol) (e.g., “Sumilizer WX-R” (trademark) available from Sumitomo Chemical Co., Ltd.), 4,4′-butylidenebis(3-methyl-6-tert-butylphenol) (e.g., “Nocrac NS-30” (trademark) available from Ouchi Shinko Chemical Industrial Co., Ltd., “ADEKA STAB AO-40” (trademark) available from ADEKA Corporation), 4,4′-thiobis(3-methyl-6-tert-butyl)phenol (e.g., “Nocrac 300” (trademark) available from Ouchi Shinko Chemical Industrial Co., Ltd.), 1,1,3-tris-(2-methyl-4-hydroxy-5-tert-butylphenyl) butane (e.g., “ADK STAB AO-30” (trademark) available from ADEKA Corporation), and ethylene bis[3,3-bis(3-tert-butyl-4-hydroxyphenyl) butyrate] (e.g., “HOSTANOX O3” (trademark) available from Clariant Chemicals).

Phenolic antioxidants may be used singly or in combination of two or more.

In the insulating material 3, the amount of the phenolic antioxidant contained relative to 100 parts by mass of the polyolefin resin is 0.01 parts by mass to 0.5 parts by mass. When the amount of the phenolic antioxidant contained is 0.01 parts by mass or more, the antioxidant effect of the polyolefin resin is further improved. When the amount of the phenolic antioxidant contained is 0.5 parts by mass or less, an increase in the dielectric loss tangent of the insulating material 3 caused by the antioxidant is unlikely to occur, and the cable 10 can have better power transmission characteristics. The lower limit of the amount of the phenolic antioxidant contained relative to 100 parts by mass of the polyolefin resin is 0.01 parts by mass or more, and may be 0.010 parts by mass or more, or 0.05 parts by mass or more. The upper limit of the amount of the phenolic antioxidant contained relative to 100 parts by mass of the polyolefin resin is 0.5 parts by mass or less, and may be 0.3 parts by mass or less. The amount of the phenolic antioxidant contained relative to 100 parts by mass of the polyolefin resin may be 0.05 parts by mass to 0.3 parts by mass. When two or more phenolic antioxidants are used, the amount of the phenolic antioxidant contained refers to the total amount of two or more phenolic antioxidants.

The insulating material 3 may contain an antioxidant other than phenolic antioxidants. The insulating material 3 may contain, for example, a sulfur-containing antioxidant other than sulfur-containing phenolic antioxidants.

### <<Copper Deactivator>>

The copper deactivator stabilizes copper ions by chelation and suppresses the degradation of the resin contained in the insulating material 3 caused by copper ions, that is, copper-induced damage. The additional inclusion of the copper deactivator in the insulating material 3 can prevent or reduce copper-induced damage and prevent or reduce the oxidative degradation of the polyolefin resin.

The copper deactivator is not limited and may be any known copper deactivator. Examples of the copper deactivator include salicylic acid derivatives, phthalic acid derivatives, complexes of triazole compounds, and aromatic secondary amine compounds. Examples of salicylic acid derivatives include NN′-bis[3-(3,5-di-t-butyl-4-hydroxyphenyl) propionyl] hydrazine (e.g., “Irganox MD1024” (trademark) available from BASF Japan Ltd.), 3-(N-salicyloyl)amino-1,2,4-triazole (“ADK STAB CDA-1” available from ADEKA Corporation), and decamethylene dicarboxylic acid disalicyloyl hydrazide (“ADK STAB CDA-6” available from ADEKA Corporation). Examples of complexes of triazole compounds include a complex (“ADK STAB CDA-IM” (trademark) available from ADEKA Corporation) containing 2-hydroxy-N-1H-1,2,4-triazole-3-ylbenzamide as a main component. Examples of aromatic secondary amine compounds include N,N′-di-2-naphthyl-p-phenylenediamine (“Nocrac White” (trademark) available from Ouchi Shinko Chemical Industrial Co., Ltd.).

Copper deactivators may be used singly or in combination of two or more.

In the insulating material 3, the amount of the copper deactivator contained relative to 100 parts by mass of the polyolefin resin is 0.01 parts by mass to 0.5 parts by mass. When the amount of the copper deactivator contained is 0.01 parts by mass or more, the copper-induced damage prevention effect is further improved. When the amount of the copper deactivator contained is 0.5 parts by mass or less, the formation of so-called bloom, where the copper-induced damage additive precipitates and crystallizes on the surface of the insulating material 3, is unlikely to occur, and the insulating material 3 tends to maintain its quality. The lower limit of the amount of the copper deactivator contained relative to 100 parts by mass of the polyolefin resin may be 0.010 parts by mass or more, or 0.05 parts by mass or more. The upper limit of the amount of the copper deactivator contained relative to 100 parts by mass of the polyolefin resin may be 0.3 parts by mass or less. The amount of the copper deactivator contained relative to 100 parts by mass of the polyolefin resin may be 0.05 parts by mass to 0.3 parts by mass. When two or more copper deactivators are used, the amount of the copper deactivator contained refers to the total amount of two or more copper deactivators.

The insulating material 3 may contain a metal deactivator other than copper deactivators.

### <<Other Components>>

The insulating material 3 may contain other components, such as a processing aid, a lubricant, and a pigment, in a range of 0.01 mass % to 2.0 mass %, in addition to the polyolefin resin, the phenolic antioxidant, and the copper deactivator.

The processing aid improves the extrusion processability of the insulating material 3. Examples of the processing aid include polytetrafluoroethylene, acrylic resin, and fluororubber.

The lubricant improves the releasability of the insulating material 3 from mixers and extruders. Examples of the lubricant include paraffin, stearic acid, zinc stearate, and fatty acid amides.

The pigment colors the insulating material 3. Various known pigments can be used as the pigment, and examples of the pigment include titanium oxide.

The dielectric loss tangent of the insulating material 3 when a high-frequency electric field with a frequency of 10 GHz is applied is 3.0×10⁻⁴ or less. Accordingly, the transmission loss reduction effect can be sufficiently improved.

The upper limit of the relative permittivity of the insulating material 3 may be 2.5 or less, or 2.3 or less. When the insulating material 3 has a relative permittivity of 2.5 or less, the transmission loss reduction effect can be sufficiently improved.

The “dielectric loss tangent” and “relative permittivity” are values measured in accordance with the methods specified in JIS-R1641 (2007).

The lower limit of the average thickness of the insulating material 3 may be 50 μm or more, or 100 μm or more. When the average thickness of the insulating material 3 is 50 μm or more, the insulating material 3 tends to ensure sufficient insulation. The upper limit of the average thickness of the insulating material 3 may be 1500 μm or less, or 1000 μm or less. When the average thickness of the insulating material 3 is 1500 μm or less, the volume efficiency of the cable 10 or other products formed by using the electric wire can be improved. The average thickness of the insulating material 3 may be 50 μm to 1500 μm, or 100 μm to 1000 μm.

In the present disclosure, the method of measuring the average thickness of the insulating material 3 is as described below. One conductor 2 is extended in a straight line, and the conductor 2 is cut along a plane perpendicular to the first direction, which connects one end of the conductor 2 to the other end, to expose the cross section. The thickness of the insulating material 3 is measured at any three locations on the cross section, and the average of these thicknesses is calculated to obtain a first average value. For one conductor 2, the conductor 2 is cut at any five locations along the plane perpendicular to the first direction, the first average value at each cut is measured, and the average of these values is calculated to obtain a second average value. The second average value corresponds to the average thickness of the insulating material 3.

### <Metal Layer>

### <Longitudinally Attached Metal Layer>

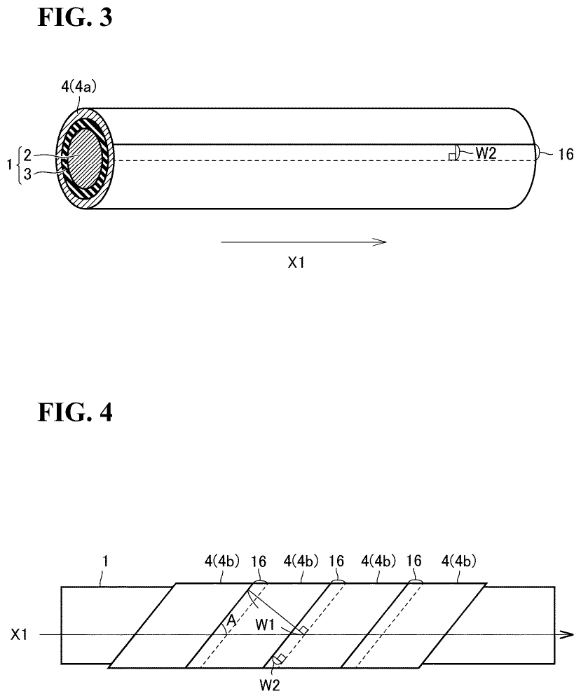

The cable 10 according to the first embodiment includes the metal layer 4 covering the electric wire 1. In the cable 10 according to the first embodiment, the metal layer 4 is composed of the longitudinally attached metal layer 4a formed by longitudinally attaching a metal tape. Referring to FIG. 3, the metal tape forms an overlapping portion 16 in which sections of the metal tape overlap in its width direction, and the overlapping portion 16 has a width W2 of 1/20 to ⅓ of the width W1 of the metal tape.

In the present disclosure, the term “longitudinally attached” means that the metal tape is wound so as to wrap the electric wire 1 in the extending direction X of the electric wire 1, as illustrated in FIG. 3. In the present disclosure, the width direction of the metal tape means the direction perpendicular to the extending direction of the metal tape.

The width W1 of the metal tape can be appropriately selected according to the circumferential length of the electric wire 1 to be covered and the width W2 of the overlapping portion in which sections of the metal tape overlap. The lower limit of the width W1 of the metal tape may be 2 mm or more, or 3 mm or more. The upper limit of the width W1 of the metal tape may be 30 mm or less, 25 mm or less, or 20 mm or less. The width W1 of the metal tape may be 2 mm to 30 mm, 3 mm to 25 mm, or 2 mm to 20 mm. In the present disclosure, the width W1 of the metal tape means the shortest distance between a set of a first side edge and a second side edge of the metal tape extending in the extending direction of the metal tape.

The metal tape forms an overlapping portion in which sections of the metal tape overlap in its width direction, and the width W2 of the overlapping portion is not limited as long as the overlapping portion has a width W2 of 1/20 to ⅓ of the width W1 of the metal tape. The width W2 of the overlapping portion may be, for example, 0.01 mm to 10 mm, or 0.015 mm to 8 mm. When the width W2 of the overlapping portion is 0.01 mm or more, the effect of suppressing the degradation of the insulating material 3 is improved. When the width W2 of the overlapping portion is 10 mm or less, the cable is more flexible, and the cost is also reduced.

The metal tape may include a multilayer structure in which a substrate film, an adhesive layer, and a metal thin layer are stacked in this order. The metal tape may have a multilayer structure in which an adhesive layer and a metal thin layer are stacked in this order on one main surface of a tape-shaped substrate film.

The metal tape having an adhesive applied to the surface of the substrate film opposite the metal thin layer is fixed to the electric wire with the adhesive after being wound around the electric wire. This configuration is preferred because the metal tape does not peel off from the electric wire.

The substrate film may be composed of polyethylene terephthalate. The substrate film may have a thickness of 1 μm to 20 μm.

The material of the adhesive layer is any material that can bond the substrate film and the metal foil together and may be any one of conventionally known materials. Examples of the material of the adhesive layer include acrylic resin, epoxy resin, urethane resin, polyolefin resin, cyanoacrylate resin, silicone resin, styrene-butadiene rubber, phenolic resin, nitrile rubber, polyamide resin, polyvinyl acetate resin, and polyvinyl alcohol resin.

The metal thin layer may be composed of aluminum or copper. The metal thin layer may be made of aluminum foil or copper foil. The metal thin layer made of aluminum foil or copper foil may have a thickness of 5 μm to 20 μm.

The metal tape may have a metal vapor deposition layer on the substrate film. In this case, the metal thin layer is composed of the metal vapor deposition layer. The metal thin layer composed of the metal vapor deposition layer may have a thickness of 0.5 μm to 2 μm.

When the metal tape is composed of a multilayer structure including the substrate film and the metal thin layer, the surface of the metal tape facing the electric wire 1 in winding the metal tape around the electric wire 1 may be the exposed surface on the substrate film side or may be the exposed surface on the metal thin layer side.

The metal tape may be a single-layer structure made of aluminum foil or copper foil. In this case, the aluminum foil or copper foil may have a thickness of 0.1 μm to 20 μm.

### <Outer Sheath>

Referring to FIG. 1, the cable 10 according to the first embodiment may further include the outer sheath 5 covering the metal layer 4. The outer sheath 5 can protect the electric wire 1 and the metal layer 4 and can impart flame resistance, oil resistance, and other functions. Furthermore, the outer sheath 5 can further suppress the degradation of the insulating material even when the cable is used in a bundle with a wire harness having an insulating material made of PVC.

### <Polyolefin Resin>

The outer sheath 5 can contain a polyolefin resin and a metal hydroxide. Examples of the polyolefin resin in the outer sheath 5 include the same polyolefin resins as described above for use in the insulating material 3. Polyolefin resins may be used singly or in combination of two or more. The polyolefin resin in the outer sheath 5 may be the same as or different from the polyolefin resin in the insulating material 3.

The lower limit of the amount of the polyolefin resin in the outer sheath 5 may be 33 mass % or more, or 35 mass % or more. When the amount of the polyolefin resin is 33 mass % or more, the mechanical properties, oil resistance, and other properties of the outer sheath 5 can be maintained in good condition. The upper limit of the amount of the polyolefin resin may be 67 mass % or less, or 60 mass % or less. When the amount of the polyolefin resin is 67 mass % or less, the flame retardancy is favorable. Furthermore, the insulating material of the cable according to the first embodiment is less likely to undergo degradation even when the cable is used in a bundle with a wire harness having an insulating material made of PVC. When two or more polyolefin resins are used, the amount of the polyolefin resin refers to the total amount of two or more polyolefin resins.

The outer sheath 5 may contain a resin other than polyolefin resins. The outer sheath 5 may contain, for example, polytetrafluoroethylene, acrylic resin, fluororubber, and other substances as processing aids in a range of 0.1 mass % to 5.0 mass %.

### <Metal Hydroxide>

The metal hydroxide undergoes dehydration accompanied by endothermic reactions at temperatures of 200° C. or higher, thereby preventing or reducing the combustion of a material containing the metal hydroxide. Furthermore, when the outer sheath contains the metal hydroxide, the insulating material of the cable according to the first embodiment is less likely to undergo degradation even when the cable is used in a bundle with a wire harness having an insulating material made of PVC. The metal hydroxide may be at least one selected from the group consisting of magnesium hydroxide and aluminum hydroxide.

In the outer sheath 5, the amount of the metal hydroxide contained relative to 100 parts by mass of the polyolefin resin may be 50 parts by mass to 200 parts by mass, or 80 parts by mass to 180 parts by mass. When two or more metal hydroxides are used, the amount of the metal hydroxide contained refers to the total amount of two or more metal hydroxides.

### <<Other Components>>

The outer sheath 5 may contain, in addition to the polyolefin resin and the metal hydroxide, other components, such as halogenated flame retardants, phosphorus flame retardants (e.g., red phosphorus, phosphate esters, and sodium hypophosphite), intumescent flame retardants, flame retardant aids (e.g., antimony trioxide, melamine cyanurate, zinc borate, zinc oxide, and zinc hydroxystannate), inorganic fillers (e.g., calcium carbonate, talc, silica, and clay), pigments, lubricants, antioxidants, copper deactivators, UV absorbers, and light stabilizers.

### Second Embodiment

A cable according to another embodiment of the present disclosure (hereinafter also referred to as a “second embodiment”) will be described with reference to FIGS. 1 and 4. FIG. 1 is a schematic cross-sectional view of a cable 10 according to the second embodiment. Referring to FIG. 1, the cable 10 according to the second embodiment includes one electric wire 1 and a metal layer 4 covering the electric wire 1. The electric wire 1 includes one conductor 2 and an insulating material 3 on the outer peripheral surface of the conductor 2. The metal layer 4 includes a transversely wound metal layer 4b formed by transversely winding a metal tape. The metal tape forms an overlapping portion in which sections of the metal tape overlap in its width direction, the overlapping portion has a width W2 of ⅕ to ½ of the width W1 of the metal tape, and the metal tape has a winding angle of more than 0° and 80° or less. The insulating material 3 of the cable 10 according to the second embodiment is less likely to undergo degradation even when the cable 10 is used in a bundle with a wire harness having an insulating material made of PVC. The cable 10 according to the second embodiment may have the same structure as that according to the first embodiment, except that the cable 10 according to the second embodiment includes the transversely wound metal layer 4b instead of the longitudinally attached metal layer 4a in the first embodiment. The transversely wound metal layer 4b will be described below.

### <Transversely Wound Metal Layer>

In the second embodiment, the metal layer 4 is composed of the transversely wound metal layer 4b formed by transversely winding a metal tape. Referring to FIG. 3, the metal tape forms an overlapping portion 16 in which sections of the metal tape overlap in its width direction, the overlapping portion 16 has a width W2 of ⅕ to ½ of the width W1 of the metal tape, and the metal tape has a winding angle A of more than 0° and 80° or less.

In the present disclosure, the term “transversely wound” means that the metal tape is spirally wound around the outer periphery of the electric wire 1, as illustrated in FIG. 4. The metal tape may have the same structure as that in the first embodiment.

The metal tape forms an overlapping portion in which sections of the metal tape overlap in its width direction, and the width W2 of the overlapping portion is not limited as long as the overlapping portion has a width W2 of ⅕ to ½ of the width W1 of the metal tape. The width W2 of the overlapping portion may be, for example, 0.4 mm to 15 mm, or 0.6 mm to 13 mm. When the width W2 of the overlapping portion is 0.4 mm or more, the effect of suppressing the degradation of the insulating material 3 is improved. When the width W2 of the overlapping portion is 15 mm or less, the cable is more flexible, and the cost is also reduced.

The winding angle of the metal tape is more than 0° and 80° or less, and may be 7° to 80°. In the present disclosure, the winding angle of the metal tape refers to the acute angle A formed between the extending direction X1 of the electric wire 1 and the side edge of the metal tape when the metal tape wound transversely around the electric wire 1 is viewed in plan, as illustrated in FIG. 4.

### Third Embodiment

A cable according to another embodiment of the present disclosure (hereinafter also referred to as a “third embodiment”) will be described with reference to FIG. 2. FIG. 2 is a schematic cross-sectional view of a cable 10 according to the third embodiment. The cable 10 according to the third embodiment may have the same structure as that according to the first embodiment or the second embodiment, except that the cable 10 according to the third embodiment further includes a metal braid 6 that covers a surface of a longitudinally attached metal layer 4a or a transversely wound metal layer 4b opposite a surface facing the electric wire 1. The metal braid 6 is disposed between the metal layer 4 and the outer sheath 5. In the cable 10 according to the third embodiment, an insulating material 3 is less likely to undergo degradation. The metal braid 6 will be described below.

The metal braid material of the metal braid 6 is preferably composed of a metal material with high electrical conductivity and high mechanical strength. Examples of such a metal material include copper and copper alloys. The metal braid may be a metal braid formed by braiding a wire made of a single metal material into a tubular shape. The metal braid may be a wire covered with another metal to form a multilayer structure. Examples of the wire having a multilayer structure include a tin-plated copper wire, a nickel-plated copper wire, a silver-plated copper wire, a copper-plated aluminum wire, and a copper-coated steel wire.

### Fourth Embodiment

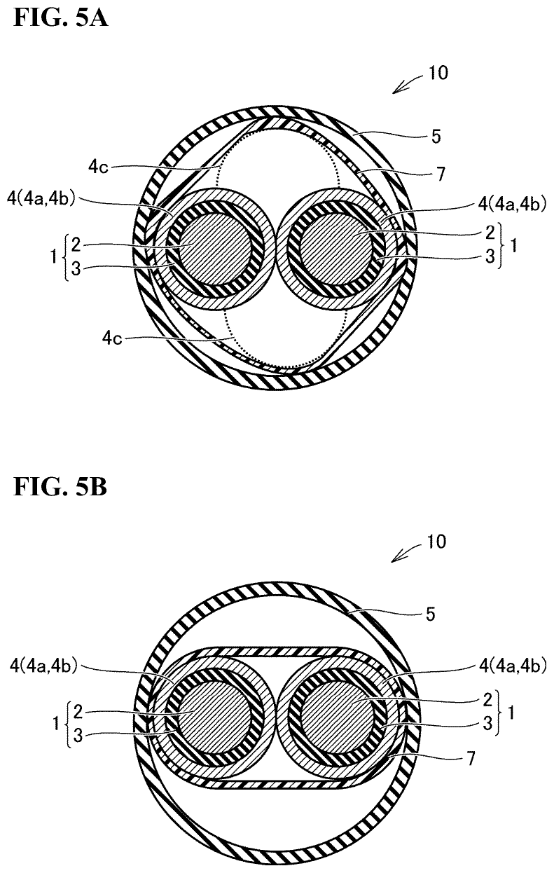

A cable according to another embodiment of the present disclosure (hereinafter also referred to as a “fourth embodiment”) will be described with reference to FIGS. 5A and 5B. FIG. 5A is a schematic cross-sectional view of an example of a cable 10 according to the fourth embodiment. FIG. 5A illustrates a so-called twisted pair cable, in which two electric wires are twisted together. In FIG. 5A, the dashed line indicates an outer edge 4c of a metal layer 4 covering the electric wires that are not exposed on the cross section. FIG. 5B is a schematic cross-sectional view of another example of the cable according to the fourth embodiment. FIG. 5B illustrates a so called two-core parallel cable, in which two electric wires are arranged in parallel.

The cable 10 according to the fourth embodiment includes two electric wires 1 and a metal layer 4 covering the two electric wires 1. Each electric wire 1 includes a conductor 2 and an insulating material 3 on the outer peripheral surface of the conductor 2. The metal layer 4 is composed of a longitudinally attached metal layer 4a or a transversely wound metal layer 4b. The two electric wires 1 covered with the metal layer 4 are transversely wrapped with a resin tape 7 (e.g., PET tape) on the outer side of the metal layer 4 to fix the relative position of the two electric wires, and an outer sheath 5 is provided on the outer side of the resin tape 7. For a twisted pair of two electric wires, as illustrated in FIG. 5A, wrapping the resin tape 7 around the outer side of the metal layer 4 of a twisted pair of the electric wires 1 prevents the twist from loosening and the relative position from shifting even when the cable is bent. For a parallel arrangement of two electric wires, as illustrated in FIG. 5B, the resin tape 7 is wrapped around the two electric wires to fix the positions of the two electric wires.

In FIGS. 5A and 5B, two electric wires 1 are illustrated, but the number of electric wires 1 is not limited. The number of electric wires 1 can be appropriately selected from two or more, depending on the application.

### Fifth Embodiment

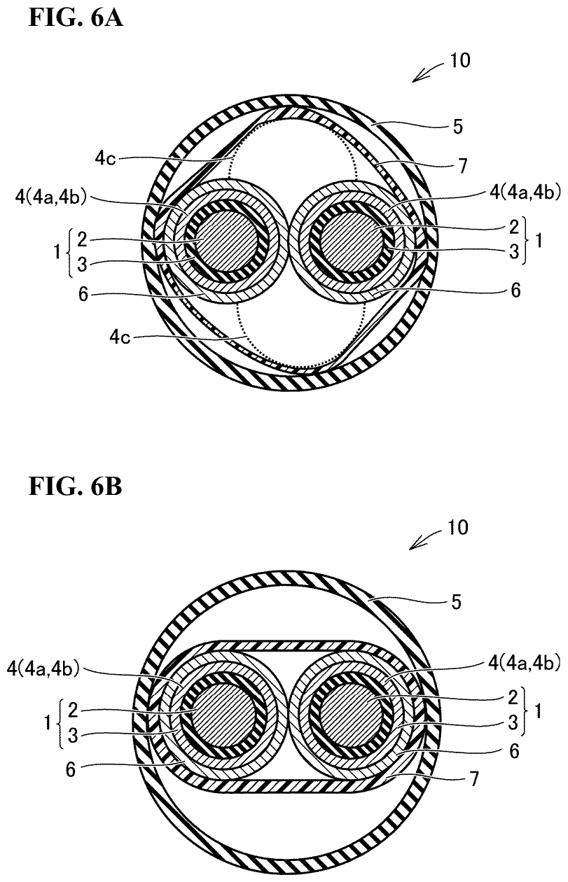

A cable according to another embodiment of the present disclosure (hereinafter also referred to as a “fifth embodiment”) will be described with reference to FIGS. 6A and 6B. FIG. 6A is a cross-sectional view of one example of a cable 10 according to the fifth embodiment. FIG. 6A illustrates a so-called twisted pair cable, in which two electric wires are twisted together. FIG. 6B is a schematic cross-sectional view of another example of the cable according to the fifth embodiment. FIG. 6B illustrates a so called two-core parallel cable, in which two electric wires are arranged in parallel.

The cable 10 according to the fifth embodiment may have the same structure as that according to the fourth embodiment, except that the cable 10 according to the fifth embodiment further includes a metal braid 6 that covers the outer periphery of a longitudinally attached metal layer 4a or the outer periphery of a transversely wound metal layer 4b. Details of the metal braid 6 are as described in the third embodiment.

### Sixth Embodiment

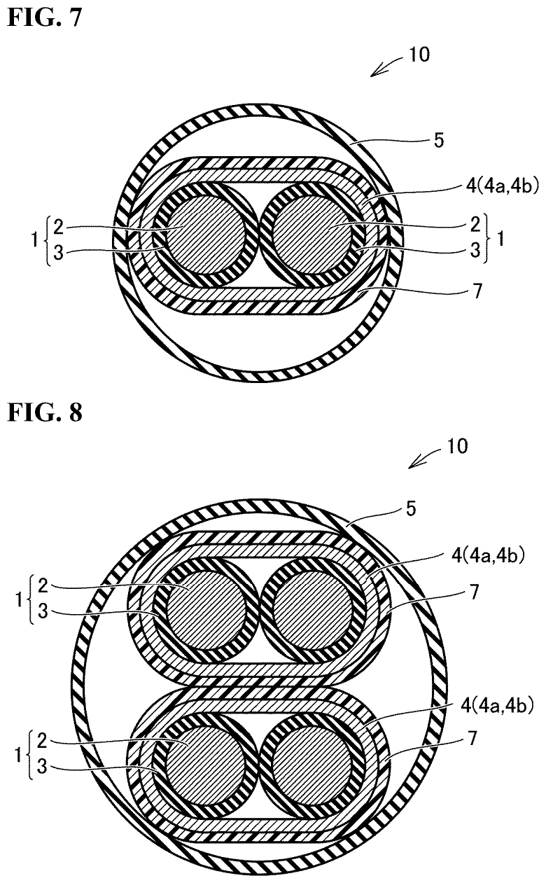

A cable according to another embodiment of the present disclosure (hereinafter also referred to as a “sixth embodiment”) will be described with reference to FIGS. 7 and 8. FIGS. 7 and 8 are schematic cross-sectional views of a cable 10 according to the sixth embodiment. The cable 10 according to the seventh embodiment may have the same structure as that according to the first embodiment or the second embodiment, except that the cable 10 according to the seventh embodiment has a first electric wire group composed of two or more electric wires 1 and the metal layer 4 collectively covers the first electric wire group. Hereinafter, the structure in which the metal layer 4 collectively covers the first electric wire group composed of two or more electric wires 1 is also referred to as a first structure. In the case of FIG. 7, a resin tape 7 is also preferably wound around the metal layer 4. In particular, when the metal layer 4 is longitudinally attached, the tape that is longitudinally attached and wound is preferably held with the resin tape 7 to prevent the longitudinally wound tape from opening.

FIGS. 7 and 8 illustrate first structures in which an electric wire group is composed of two electric wires 1; however, the number of electric wires 1 included in one electric wire group is not limited, and one electric wire group may include two or more electric wires depending on the application. In FIG. 7, one cable 10 includes one first structure, but the number of first structures included in one cable 10 is not limited, and one cable 10 may include two or more first structures depending on the application. For example, as illustrated in FIG. 8, one cable 10 may include two first structures.

### Seventh Embodiment

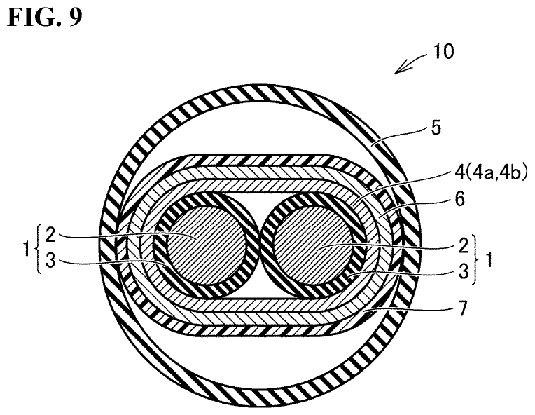

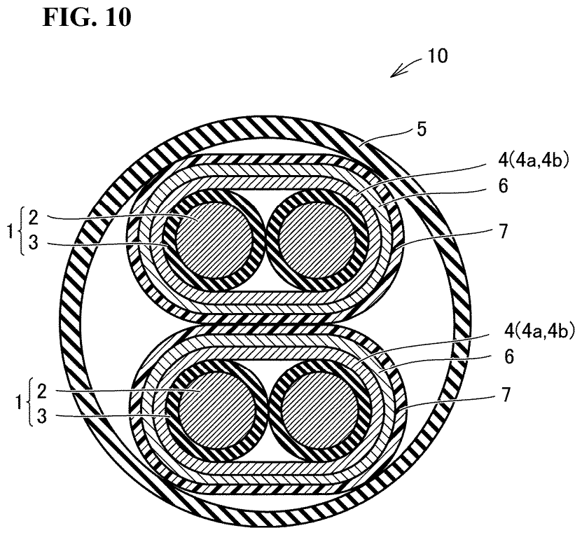

A cable according to another embodiment of the present disclosure (hereinafter also referred to as a “seventh embodiment”) will be described with reference to FIGS. 9 and 10. FIGS. 9 and 10 are schematic cross-sectional views of a cable 10 according to the seventh embodiment. The cable 10 according to the seventh embodiment may have the same structure as that according to the sixth embodiment, except that the cable 10 according to the seventh embodiment further includes a metal braid 6 that covers a surface of the longitudinally attached metal layer 4a or the transversely wound metal layer 4b opposite a surface facing the electric wire 1. Details of the metal braid 6 are as described in the third embodiment.

### Examples

The embodiments of the present disclosure will be further described in more detail by way of Examples. However, the embodiments of the present disclosure are not limited by these Examples.

### [Degradation Suppression Evaluation Test for Insulating Material]

### <Preparation of Test Samples>

To evaluate the effect of the metal layer on suppressing the degradation of the insulating material, test samples were prepared according to the following procedure.

As a conductor, a stranded wire (AWG26) composed of seven solid conductors made of tin-plated annealed copper and each having a diameter of 0.16 mm was prepared. An insulating material having a thickness of 0.36 mm was formed on the outer peripheral surface of the conductor by extrusion to obtain an electric wire. The composition of the insulating material is described in the “Insulating Material” column in Tables 1 and 2. The “Polyolefin Resin” under the “Insulating Material” column in Tables 1 and 5 is block polypropylene, the “Antioxidant” is a hindered phenolic antioxidant, and the “Copper Deactivator” is a copper deactivator having a hydrazide structure. In all samples, the insulating material was prepared using a polyolefin resin, an antioxidant, and a copper deactivator as raw materials, and no other components were used as raw materials. In each sample, one or two electric wires were prepared. When two electric wires were prepared, two electric wires were twisted together to form a twisted pair.

A metal tape in which aluminum foil (corresponding to the metal thin layer) was attached to a PET (polyethylene terephthalate) substrate was wound around the outer peripheral surface of the electric wire to form a longitudinally attached metal layer or a transversely wound metal layer. The width W1 of the metal tape and the thickness of the aluminum foil (corresponding to the metal thin layer) are as described in the “Metal Tape Width W1” and “Metal Thin Layer Thickness” columns in Tables 2 and 6. The covering method for the metal tape in each sample is as described in the “Covering Method” column in Tables 2 and 6. The “longitudinal attachment” indicates that the metal tape is longitudinally attached to and wound around the outer peripheral surface of the electric wire. The “transverse winding” indicates that the metal tape is transversely wound around the outer peripheral surface of the electric wire. The “individual” indicates that each electric wire is covered with the metal tape. The “collective” indicates that two electric wires are collectively covered with the metal tape. The width W2 of the overlapping portion of the longitudinally attached or transversely wound metal tape and the ratio W2/W1 of the width W2 of the overlapping portion to the width W1 of the metal tape are as described in the “Overlapping Portion Width W2” and “W2/W1” columns in Tables 2 and 6.

In the samples marked “present” in the “Metal Braid” column in Tables 2 and 6, the longitudinally attached metal layer or the transversely wound metal layer was covered with the metal braid. The metal braid is composed of a tin-plated annealed copper wire with a wire diameter of 0.1 mm and has a thickness of 0.4 mm. For one electric wire, two electric wires covered with the metal tape were twisted together as a pair, and the twisted pair of electric wires was covered with the metal braid.

The outer side of the metal layer or metal braid was further covered with a 0.6 mm-thick outer sheath by extrusion to obtain a test sample. The composition of the outer sheath is as described in the “Outer Sheath” column in Tables 3 and 7. The “Polyolefin Resin” described in the “Outer Sheath” column in Tables 3 and 7 is block polypropylene. In all samples, no components other than polyolefin resin, Mg(OH)₂, and Al(OH₃) were used as raw materials for the outer sheath. For one electric wire, two electric wires covered with a metal tape were twisted together as a pair, and the twisted pair of electric wires was covered with the outer sheath.

TABLE 1

| | Electric Wire | | | | | |
|---|---|---|---|---|---|---|
| | | Insulating Material | | | | |
| | Number | Polyolefin | Anti- | Copper | Dielectric | |
| | of | Resin | oxidant | Deactivator | Loss | |
| | Electric | parts by | parts by | parts by | Tangent | Relative |
| Sample No. | Wires | mass | mass | mass | (×10⁻⁴) | Permittivity |
| 1 | 1 | 100 | 0.01 | 0.01 | 2.1 | 2.2 |
| 2 | 1 | 100 | 0.50 | 0.50 | 2.9 | 2.2 |
| 3 | 1 | 100 | 0.01 | 0.01 | 2.1 | 2.2 |
| 4 | 1 | 100 | 0.01 | 0.01 | 2.1 | 2.2 |
| 5 | 1 | 100 | 0.01 | 0.01 | 2.1 | 2.2 |
| 6 | 1 | 100 | 0.50 | 0.50 | 2.8 | 2.2 |
| 7 | 2 | 100 | 0.01 | 0.01 | 2.1 | 2.2 |
| 8 | 2 | 100 | 0.50 | 0.50 | 2.9 | 2.2 |
| 9 | 2 | 100 | 0.01 | 0.01 | 2.1 | 2.2 |
| 10 | 2 | 100 | 0.01 | 0.01 | 2.1 | 2.2 |
| 11 | 2 | 100 | 0.01 | 0.01 | 2.1 | 2.2 |
| 12 | 2 | 100 | 0.50 | 0.50 | 2.9 | 2.2 |
| 1-1 | 1 | 100 | 0.005 | 0.005 | 1.9 | 2.2 |
| 1-2 | 1 | 100 | 0.01 | 0.01 | 2.1 | 2.2 |
| 1-3 | 2 | 100 | 0.005 | 0.005 | 1.9 | 2.2 |
| 1-4 | 2 | 100 | 0.01 | 0.01 | 2.1 | 2.2 |
| 1-5 | 1 | 100 | 4.00 | 0.50 | 4.2 | 2.4 |
| 1-6 | 1 | 100 | 0.80 | 0.80 | 3.2 | 2.2 |
| 1-7 | 2 | 100 | 0.80 | 0.80 | 3.2 | 2.2 |
| 1-8 | 1 | 100 | 0.50 | 0.50 | 2.9 | 2.2 |
| 1-9 | 2 | 100 | 0.50 | 0.50 | 2.9 | 2.2 |

TABLE 2

| | Metal Layer | | | | | | |
|---|---|---|---|---|---|---|---|
| | Longitudinally Attached Metal Layer | | | | | | |
| | | | | Over- | | | |
| | | | Metal | lapping | | | Metal |
| | | | Tape | Portion | | Metal Thin | Braid |
| | | | Width | Width | | Layer | Presence |
| Sample | | | W1 | W2 | W2/ | Thickness | or |
| No. | Covering Method | | (mm) | (mm) | W1 | (μm) | Absence |
| 1 | longitudinal | individual | 4.0 | 0.2 | 1/20 | 6 | present |
| | attachment | | | | | | |
| 2 | longitudinal | individual | 5.7 | 1.9 | 1/3 | 12 | absent |
| | attachment | | | | | | |
| 3 | longitudinal | individual | 4.0 | 0.2 | 1/20 | 6 | absent |
| | attachment | | | | | | |
| 4 | longitudinal | individual | 4.0 | 0.2 | 1/20 | 6 | absent |
| | attachment | | | | | | |
| 5 | longitudinal | individual | 4.0 | 0.2 | 1/20 | 6 | absent |
| | attachment | | | | | | |
| 6 | longitudinal | individual | 5.7 | 1.9 | 1/3 | 12 | absent |
| | attachment | | | | | | |
| 7 | longitudinal | collective | 7.4 | 0.4 | 1/20 | 6 | present |
| | attachment | | | | | | |
| 8 | longitudinal | collective | 10.5 | 3.5 | 1/3 | 12 | absent |
| | attachment | | | | | | |
| 9 | longitudinal | collective | 7.4 | 0.4 | 1/20 | 6 | absent |
| | attachment | | | | | | |
| 10 | longitudinal | collective | 7.4 | 0.4 | 1/20 | 6 | absent |
| | attachment | | | | | | |
| 11 | longitudinal | collective | 7.4 | 0.4 | 1/20 | 6 | absent |
| | attachment | | | | | | |
| 12 | longitudinal | collective | 10.5 | 3.5 | 1/3 | 12 | absent |
| | attachment | | | | | | |
| 1-1 | longitudinal | individual | 4.0 | 0.2 | 1/20 | 6 | present |
| | attachment | | | | | | |
| 1-2 | longitudinal | individual | 3.9 | 0.1 | 1/39 | 6 | absent |
| | attachment | | | | | | |
| 1-3 | longitudinal | collective | 4.0 | 0.2 | 1/20 | 6 | present |
| | attachment | | | | | | |
| 1-4 | longitudinal | collective | 3.9 | 0.1 | 1/39 | 6 | absent |
| | attachment | | | | | | |
| 1-5 | longitudinal | individual | 4.0 | 0.2 | 1/20 | 6 | absent |
| | attachment | | | | | | |
| 1-6 | longitudinal | individual | 5.7 | 1.9 | 1/3 | 12 | absent |
| | attachment | | | | | | |
| 1-7 | longitudinal | collective | 5.7 | 1.9 | 1/3 | 12 | absent |
| | attachment | | | | | | |
| 1-8 | longitudinal | individual | 7.6 | 3.8 | 1/2 | 6 | absent |
| | attachment | | | | | | |
| 1-9 | longitudinal | collective | 7.6 | 3.8 | 1/2 | 6 | absent |
| | attachment | | | | | | |

TABLE 3

| | Outer Sheath | | |
|---|---|---|---|
| | Polyolefin Resin | Mg(OH)₂ | Al(OH)₃ |
| Sample No. | parts by mass | parts by mass | parts by mass |
| 1 | 100 | 50 | — |
| 2 | 100 | 200 | — |
| 3 | 100 | 10 | — |
| 4 | 100 | 250 | — |
| 5 | 100 | — | 100 |
| 6 | 100 | 200 | — |
| 7 | 100 | 50 | — |
| 8 | 100 | 200 | — |
| 9 | 100 | 10 | — |
| 10 | 100 | 250 | — |
| 11 | 100 | — | 100 |
| 12 | 100 | 200 | — |
| 1-1 | 100 | 50 | — |
| 1-2 | 100 | 10 | — |
| 1-3 | 100 | 50 | — |
| 1-4 | 100 | 10 | — |
| 1-5 | 100 | — | — |
| 1-6 | 100 | 200 | — |
| 1-7 | 100 | 200 | — |
| 1-8 | 100 | 250 | — |
| 1-9 | 100 | 250 | — |

TABLE 4

| | Evaluation | | | |
|---|---|---|---|---|
| | Degradation | | | |
| | Suppression | | | |
| Sample | Evaluation Test | Heat Aging | | Abrasion |
| No. | time (hr) | Resistance | Flexibility | Resistance |
| 1 | >3000 | A | A | A |
| 2 | >3000 | A | A | A |
| 3 | >3000 | A | A | A |
| 4 | >3000 | A | A | B |
| 5 | >3000 | A | A | A |
| 6 | >3000 | A | A | A |
| 7 | >3000 | A | A | A |
| 8 | >3000 | A | A | A |
| 9 | >3000 | A | A | A |
| 10 | >3000 | A | A | B |
| 11 | >3000 | A | A | A |
| 12 | >3000 | A | A | A |
| 1-1 | — | B | — | — |
| 1-2 | <1000 | — | — | — |
| 1-3 | — | B | — | — |
| 1-4 | <1000 | — | — | — |
| 1-5 | — | — | — | — |
| 1-6 | — | — | — | — |
| 1-7 | — | — | — | — |
| 1-8 | — | — | B | B |
| 1-9 | — | — | B | B |

TABLE 5

| | Electric Wire | | | | | |
|---|---|---|---|---|---|---|
| | | Insulating Material | | | | |
| | | Polyolefin | Anti- | Copper | | |
| | Number of | Resin | oxidant | Deactivator | Dielectric | |
| | Electric | parts by | parts by | parts by | Loss Tangent | Relative |
| Sample No. | Wires | mass | mass | mass | (×10⁻⁴) | Permittivity |
| 101 | 1 | 100 | 0.01 | 0.01 | 2.1 | 2.2 |
| 102 | 1 | 100 | 0.50 | 0.50 | 2.9 | 2.2 |
| 103 | 1 | 100 | 0.01 | 0.01 | 2.1 | 2.2 |
| 104 | 1 | 100 | 0.01 | 0.01 | 2.1 | 2.2 |
| 105 | 1 | 100 | 0.01 | 0.01 | 2.1 | 2.2 |
| 106 | 1 | 100 | 0.50 | 0.50 | 2.8 | 2.2 |
| 107 | 2 | 100 | 0.01 | 0.01 | 2.1 | 2.2 |
| 108 | 2 | 100 | 0.50 | 0.50 | 2.9 | 2.2 |
| 109 | 2 | 100 | 0.01 | 0.01 | 2.1 | 2.2 |
| 110 | 2 | 100 | 0.01 | 0.01 | 2.1 | 2.2 |
| 111 | 2 | 100 | 0.01 | 0.01 | 2.1 | 2.2 |
| 112 | 2 | 100 | 0.50 | 0.50 | 2.9 | 2.2 |
| 2-1 | 1 | 100 | 0.005 | 0.005 | 1.9 | 2.2 |
| 2-2 | 1 | 100 | 0.01 | 0.01 | 2.1 | 2.2 |
| 2-3 | 2 | 100 | 0.005 | 0.005 | 1.9 | 2.2 |
| 2-4 | 2 | 100 | 0.01 | 0.01 | 2.1 | 2.2 |
| 2-5 | 1 | 100 | 0.80 | 0.80 | 3.2 | 2.2 |
| 2-6 | 2 | 100 | 0.80 | 0.80 | 3.2 | 2.2 |
| 2-7 | 1 | 100 | 0.50 | 0.50 | 2.9 | 2.2 |
| 2-8 | 2 | 100 | 0.50 | 0.50 | 2.9 | 2.2 |

TABLE 6

| | Metal Layer | | | | | | | |
|---|---|---|---|---|---|---|---|---|
| | Transversely Wound Metal Layer | | | | | | | |
| | | | | Over- | | | | |
| | | | Metal | lapping | | | Metal | Metal |
| | | | Tape | Portion | | | Thin | Braid |
| | | | Width | Width | | Winding | Layer | Presence |
| Sample | | | W1 | W2 | W2/ | Angle | Thickness | or |
| No. | Covering Method | | (mm) | (mm) | W1 | (°) | (μm) | Absence |
| 101 | transverse | individual | 4 | 0.8 | 1/5 | 32 | 6 | present |
| | winding | | | | | | | |
| 102 | transverse | individual | 6 | 3.0 | 1/2 | 37 | 12 | absent |
| | winding | | | | | | | |
| 103 | transverse | individual | 4 | 0.8 | 1/5 | 32 | 6 | absent |
| | winding | | | | | | | |
| 104 | transverse | individual | 4 | 0.8 | 1/5 | 32 | 12 | absent |
| | winding | | | | | | | |
| 105 | transverse | individual | 4 | 0.8 | 1/5 | 32 | 6 | absent |
| | winding | | | | | | | |
| 106 | transverse | individual | 6 | 3.0 | 1/2 | 37 | 12 | absent |
| | winding | | | | | | | |
| 107 | transverse | collective | 8 | 1.6 | 1/5 | 32 | 6 | present |
| | winding | | | | | | | |
| 108 | transverse | collective | 10 | 5.0 | 1/2 | 47 | 12 | absent |
| | winding | | | | | | | |
| 109 | transverse | collective | 8 | 1.6 | 1/5 | 32 | 6 | absent |
| | winding | | | | | | | |
| 110 | transverse | collective | 8 | 1.6 | 1/5 | 32 | 6 | absent |
| | winding | | | | | | | |
| 111 | transverse | collective | 8 | 1.6 | 1/5 | 32 | 6 | absent |
| | winding | | | | | | | |
| 112 | transverse | collective | 10 | 5.0 | 1/2 | 47 | 12 | absent |
| | winding | | | | | | | |
| 2-1 | transverse | individual | 4 | 0.8 | 1/5 | 32 | 6 | present |
| | winding | | | | | | | |
| 2-2 | transverse | individual | 4 | 0.4 | 1/10 | 19 | 6 | absent |
| | winding | | | | | | | |
| 2-3 | transverse | collective | 8 | 1.6 | 1/5 | 32 | 6 | present |
| | winding | | | | | | | |
| 2-4 | transverse | collective | 6 | 0.6 | 1/10 | 8 | 6 | absent |
| | winding | | | | | | | |
| 2-5 | transverse | individual | 6 | 3.0 | 1/2 | 37 | 12 | absent |
| | winding | | | | | | | |
| 2-6 | transverse | collective | 10 | 5.0 | 1/2 | 47 | 12 | absent |
| | winding | | | | | | | |
| 2-7 | transverse | individual | 6 | 4.0 | 2/3 | 56.5 | 6 | absent |
| | winding | | | | | | | |
| 2-8 | transverse | collective | 9 | 6.0 | 2/3 | 68 | 6 | absent |
| | winding | | | | | | | |

TABLE 7

| | Outer Sheath | | |
|---|---|---|---|
| | Polyolefin Resin | Mg(OH)₂ | Al(OH)₃ |
| Sample No. | parts by mass | parts by mass | parts by mass |
| 101 | 100 | 50 | — |
| 102 | 100 | 200 | — |
| 103 | 100 | 10 | — |
| 104 | 100 | 250 | — |
| 105 | 100 | — | 100 |
| 106 | 100 | 200 | — |
| 107 | 100 | 50 | — |
| 108 | 100 | 200 | — |
| 109 | 100 | 10 | — |
| 110 | 100 | 250 | — |
| 111 | 100 | — | 100 |
| 112 | 100 | 200 | — |
| 2-1 | 100 | 50 | — |
| 2-2 | 100 | 10 | — |
| 2-3 | 100 | 50 | — |
| 2-4 | 100 | 10 | — |
| 2-5 | 100 | 200 | — |
| 2-6 | 100 | 200 | — |
| 2-7 | 100 | 250 | — |
| 2-8 | 100 | 250 | — |

TABLE 8

| | Evaluation | | | |
|---|---|---|---|---|
| | Degradation | | | |
| | Suppression | | | |
| Sample | Evaluation Test | Heat Aging | | Abrasion |
| No. | time (hr) | Resistance | Flexibility | Resistance |
| 101 | >3000 | A | A | A |
| 102 | >3000 | A | A | A |
| 103 | >3000 | A | A | A |
| 104 | >3000 | A | A | B |
| 105 | >3000 | A | A | A |
| 106 | >3000 | A | A | A |
| 107 | >3000 | A | A | A |
| 108 | >3000 | A | A | A |
| 109 | >3000 | A | A | A |
| 110 | >3000 | A | A | B |
| 111 | >3000 | A | A | A |
| 112 | >3000 | A | A | A |
| 2-1 | — | B | — | — |
| 2-2 | <1000 | — | — | — |
| 2-3 | — | B | — | — |
| 2-4 | <1000 | — | — | — |
| 2-5 | — | — | — | — |
| 2-6 | — | — | — | — |
| 2-7 | — | — | B | B |
| 2-8 | — | — | B | B |

### [Degradation Suppression Evaluation Test]

The test samples were brought into contact with PVC at 100° C., and the time until any visual abnormality appeared in the insulating material was measured. The longer until visual abnormalities appear in the insulating material, the more the degradation of the insulating material is suppressed. The specific test method is as described below.

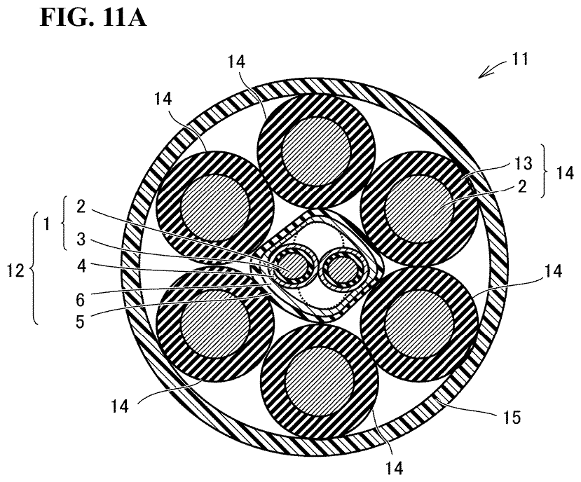

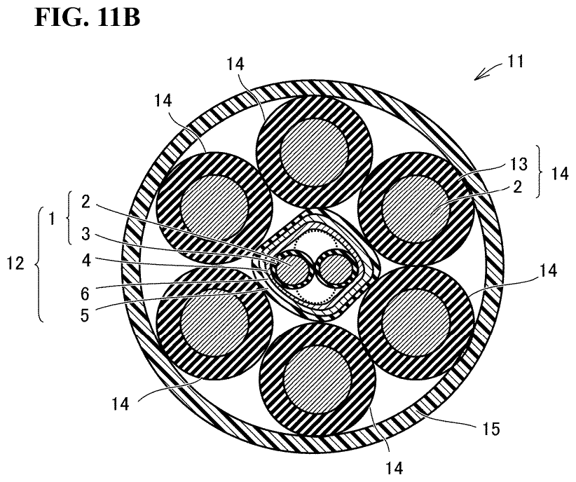

FIGS. 11A and 11B are cross-sectional views of test structures 11 used in the degradation suppression evaluation test for the insulating material.

FIG. 11A is a cross-sectional view of the test structure 11 using a test sample 12 with one electric wire. Referring to FIG. 11A, the test structure 11 includes the test sample 12 and six PVC-coated electric wires 14 arranged to surround the test sample 12. The test sample 12 and the six PVC-coated electric wires 14 are bundled together with a PVC tape 15.

FIG. 11B is a cross-sectional view of the test structure using a test sample with two electric wires. Referring to FIG. 11B, the test structure 11 includes the test sample 12 and six PVC-coated electric wires 14 closely arranged to surround the test sample 12. The test sample 12 and the six PVC-coated electric wires 14 are bundled together with a PVC tape 15.

The PVC-coated electric wires 14 are each composed of a conductor 2 (a stranded wire composed of 65 solid conductors each having a diameter of 0.32 mm and made of tin-plated annealed copper, diameter: 3.0 mm) and a PVC insulating material 13 (diameter: 4.6 mm) covering the outer periphery of the conductor 2, made of cross-linked polyvinyl chloride, and having a thickness of 0.8 mm.

As the PVC tape in the test structure 11, a VTA tape (thickness 0.135 mm, width 19 mm) available from YAZAKI Corporation was used. The VTA tape was applied in a half-lap wrap to bundle the test sample 12 and the PVC-coated electric wires 14 together, thereby forming the test structure 11.

In the degradation suppression evaluation test, multiple test structures 11 are placed in an oven with a 100° C. atmosphere and removed after 1,000 hours, 2,000 hours, and 3,000 hours. Next, each of the test structures 11 is disassembled to remove the electric wire, and the electric wire is wound halfway around an electric-wire-diameter mandrel in the circumferential direction. The electric-wire-diameter mandrel refers to a mandrel having the same diameter as the electric wire. The circumferential length of the electric wire wound around the electric-wire-diameter mandrel elongates to 1.5 times the length of the electric wire at its center.

In the degradation suppression evaluation test, the insulating material of the electric wire wound around the electric-wire-diameter mandrel is visually inspected for any visual abnormalities, such as cracks, splits, and conductor exposure. The time at which any visual abnormalities are observed is referred to as the “visual abnormality occurrence time.” The results are described in the “time” column in the “Degradation Suppression Evaluation Test” under “Evaluation” in Tables 4 and 8. In Tables 4 and 8, “>3000” indicates that no visual abnormalities were observed at the time point after 3000 hours. In Tables 4 and 8, “<1000” indicates that visual abnormalities were observed at the elapsed time of 1000 hours. The longer the visual abnormality occurrence time, the greater the effect of suppressing the degradation of the insulating material. The samples marked “-” in the relevant column have not undergone the degradation suppression evaluation test.

### [Heat Aging Test]

As a conductor, a stranded wire (AWG26) composed of seven solid conductors made of tin-plated annealed copper and each having a diameter of 0.16 mm was prepared. An insulating material having a thickness of 0.36 mm was formed on the outer peripheral surface of the conductor by extrusion to obtain an electric wire. The length of the electric wire was 350 mm. The heat aging test was conducted on the electric wire of each sample in accordance with ISO 6722 standard (Class B). As the heat aging test, a long-term aging test and a short-term aging test were conducted. The test conditions for each test are as described below.

### <Long-Term Aging Test>

The electric wire was heated at 100° C. in a thermostatic chamber for 3,000 hours, then removed, and kept at room temperature for 16 hours. The electric wire was then wound three times around a mandrel having a diameter five times the diameter of the electric wire at room temperature. The test was considered passed if no cracks were observed in the insulating material and no insulation breakdown occurred during the withstand voltage test by immersion in saltwater (1 kV×1 minute).

### <Short-Term Aging Test>

The electric wire was heated at 125° C. in a thermostatic chamber for 240 hours, then removed, and kept at room temperature for 16 hours. The electric wire was then wound three times around mandrels having diameters five times the diameters of the electric wire and the cable at −25° C. The test was considered passed if no cracks were observed in the insulating material and no insulation breakdown occurred during the withstand voltage test by immersion in saltwater (1 kV×1 minute).

The results are described in the “Heat Aging Resistance” column under “Evaluation” in Tables 1 and 2. In Tables 1 and 2, “A” indicates that the sample passed both the long-term aging test and the short-term aging test, while “B” indicates that the sample failed at least one of the long-term aging test and the short-term aging test. The samples marked “-” in the relevant column have not undergone the heat aging test.

### [Flexibility Test]

For each sample, a flexibility test sample was prepared by covering the test sample 12 in FIGS. 11A and 11B with the resin tape 7. A compression test fixture was attached to a tensile testing machine, the flexibility test sample was secured to the fixture, and the reaction force was measured and evaluated when the flexibility test sample was bent to a bending radius of 25 mm. For the evaluation criteria for bending performance, samples with a bending reaction force of 1 N or less were rated as acceptable, and those with a bending reaction force exceeding 1 N were rated as unacceptable.

The results are described in the “Flexibility” column under “Evaluation” in Tables 4 and 8. In Tables 4 and 8, “A” indicates that the sample passed the test, while “B” indicates that the sample failed the test. The samples marked “-” in the relevant column have not undergone the flexibility test.

### [Abrasion Resistance Test]

For each sample, the test sample 12 in FIGS. 11A and 11B was prepared. The strength of the outer sheath was measured using a scrape abrasion test in accordance with ISO 6722 standard. The test was conducted with a needle diameter of 0.45 mm, a load of 7 N, and an operating speed of 55 cycles/min. The test was considered passed if the number of cycles required for the metal braid or metal tape to be exposed was 200 or more.

The results are described in the “Abrasion Resistance” column under “Evaluation” in Tables 4 and 8. In Tables 4 and 8, “A” indicates that the sample passed the test, while “B” indicates that the sample failed the test.

### [Evaluation of Insulating Material]

### <Preparation of Test Insulating Sheet>

To measure the dielectric loss tangent and relative permittivity of the insulating material used in the test sample 12 and to conduct the heat aging test, a test insulating sheet was prepared according to the following procedure.

A resin composition for the insulating material was obtained by mixing a polyolefin resin, an antioxidant, and a copper deactivator in the ratio described in the “Insulating Material” column in Tables 1 and 2. The resin composition for the insulating material was press-molded into a test insulating sheet. The press-molding conditions were as follows: the resin composition was preheated at 180° C. for 5 minutes, then pressed at that temperature, and held for 5 minutes.

### <Measurement of Dielectric Loss Tangent and Relative Permittivity>

The “dielectric loss tangent” and “relative permittivity” of the test insulating sheet were measured by applying a high-frequency electric field at a frequency of 10 GHz in accordance with the method specified in JIS-R1641 (2007). The measurements were performed three times, and the average value was calculated. The results are described in the “Dielectric Loss Tangent” and “Relative Permittivity” columns in Tables 1 and 2.

### [Discussion]

Samples 1 to 12 and Samples 101 to 112 correspond to Examples. In Samples 1 to 12 and Samples 101 to 112, the insulating material exhibited no increase in dielectric loss tangent, and the effect of suppressing the degradation of the insulating material was high.

Samples 1-1 to 1-9 and Samples 2-1 to 2-8 correspond to Comparative Examples. Sample 1-1, Sample 1-3, Sample 2-1, and Sample 2-3 were rated “B”, which means failure, in the heat aging test and were not subjected to other tests. Sample 1-2, Sample 1-4, Sample 2-2, and Sample 2-4 were not subjected to other tests due to poor suppression of degradation. Sample 1-5, Sample 1-6, Sample 1-7, Sample 2-5, and Sample 2-6 were not subjected to other tests because the dielectric loss tangent was more than 3.0×10⁻⁴. Sample 1-8, Sample 1-9, Sample 2-7, and Sample 2-8 were rated “B”, which means failure, in the flexibility test and were not subjected to tests for degradation suppression and heat aging resistance.

The embodiments and examples of the present disclosure are described above; however, it has already been presumed that the configurations of the embodiments and examples may be combined as appropriate and variously modified.

The embodiments and examples disclosed herein are for illustrative purposes in any respect and should not be construed as restrictive. The scope of the present invention is defined by the claims rather than by the embodiments and examples. The scope of the present disclosure is intended to encompass all modifications within the meaning and range of equivalency of the claims.

### REFERENCE SIGNS LIST

1 electric wire
2 conductor
3 insulating material
4 metal layer
4a longitudinally attached metal layer
4b transversely wound metal layer
4c outer edge of metal layer
5 outer sheath
6 metal braid
7 resin tape
10 cable
11 test structure
12 test sample
13 PVC insulating material
14 PVC-coated electric wire
15 PVC tape
16 overlapping portion

1. A cable comprising: an electric wire; and a metal layer covering the electric wire,
wherein the electric wire includes a conductor and an insulating material on an outer peripheral surface of the conductor,
the insulating material contains a polyolefin resin, a phenolic antioxidant, and a copper deactivator,
an amount of the polyolefin resin in the insulating material is 98 mass % or more,
the insulating material contains 0.01 parts by mass to 0.5 parts by mass of the phenolic antioxidant and 0.01 parts by mass to 0.5 parts by mass of the copper deactivator relative to 100 parts by mass of the polyolefin resin, and has a dielectric loss tangent of 3.0×10⁻⁴ or less at 10 GHz,
the metal layer includes a longitudinally attached metal layer formed by longitudinally attaching a metal tape,
the metal tape forms an overlapping portion in which sections of the metal tape overlap in its width direction, and
the overlapping portion has a width of 1/20 to ⅓ of a width of the metal tape.

2. A cable comprising: an electric wire; and a metal layer covering the electric wire,
wherein the electric wire includes a conductor and an insulating material on an outer peripheral surface of the conductor,
the insulating material contains a polyolefin resin, a phenolic antioxidant, and a copper deactivator,
an amount of the polyolefin resin in the insulating material is 98 mass % or more,
the insulating material contains 0.01 parts by mass to 0.5 parts by mass of the phenolic antioxidant and 0.01 parts by mass to 0.5 parts by mass of the copper deactivator relative to 100 parts by mass of the polyolefin resin, and has a dielectric loss tangent of 3.0×10⁻⁴ or less at 10 GHZ,
the metal layer includes a transversely wound metal layer formed by transversely winding a metal tape,
the metal tape forms an overlapping portion in which sections of the metal tape overlap in its width direction,
the overlapping portion has a width of ⅕ to ½ of a width of the metal tape, and
the metal tape has a winding angle of more than 0° and 80° or less.

3. The cable according to claim 1, wherein
the cable includes a plurality of electric wires each being the electric wire, and
the metal layer covers each of the electric wires.

4. The cable according to claim 1, wherein
the cable includes a first electric wire group composed of two or more electric wires each being the electric wire, and
the metal layer collectively covers the first electric wire group.

5. The cable according to claim 1, further comprising a metal braid covering a surface of the metal layer opposite a surface facing the electric wire.

6. The cable according to claim 1, wherein
the metal tape includes a metal thin layer, and
the metal thin layer has a thickness of 0.1 μm to 20 μm.

7. The cable according to claim 1, wherein the polyolefin resin is polypropylene resin.

8. The cable according to claim 1, further comprising an outer sheath covering the metal layer,
wherein the outer sheath contains a polyolefin resin and a metal hydroxide,
the metal hydroxide is at least one selected from the group consisting of magnesium hydroxide and aluminum hydroxide, and
the outer sheath contains 50 parts by mass to 200 parts by mass of the metal hydroxide relative to 100 parts by mass of the polyolefin resin.

9. The cable according to claim 1, wherein
the metal tape includes a multilayer structure in which a substrate film, an adhesive layer, and a metal thin layer are stacked in this order,
the substrate film is composed of polyethylene terephthalate, and
the metal thin layer contains aluminum or copper.

10. The cable according to claim 1, wherein the metal tape is made of aluminum foil or copper foil.

11. The cable according to claim 1, wherein
the cable includes two electric wires each being the electric wire, and
the two electric wires are twisted together as a pair.

12. The cable according to claim 1, wherein
the cable includes two electric wires each being the electric wire, and
a resin tape is transversely wound around the two electric wires.

13. The cable according to claim 2, wherein
the cable includes a plurality of electric wires each being the electric wire, and
the metal layer covers each of the electric wires.

14. The cable according to claim 2, wherein
the cable includes a first electric wire group composed of two or more electric wires each being the electric wire, and
the metal layer collectively covers the first electric wire group.

15. The cable according to claim 2, further comprising a metal braid covering a surface of the metal layer opposite a surface facing the electric wire.

16. The cable according to claim 2, wherein
the metal tape includes a metal thin layer, and
the metal thin layer has a thickness of 0.1 μm to 20 μm.

17. The cable according to claim 2, wherein the polyolefin resin is polypropylene resin.

18. The cable according to claim 2, further comprising an outer sheath covering the metal layer,
wherein the outer sheath contains a polyolefin resin and a metal hydroxide,
the metal hydroxide is at least one selected from the group consisting of magnesium hydroxide and aluminum hydroxide, and
the outer sheath contains 50 parts by mass to 200 parts by mass of the metal hydroxide relative to 100 parts by mass of the polyolefin resin.

19. The cable according to claim 2, wherein
the metal tape includes a multilayer structure in which a substrate film, an adhesive layer, and a metal thin layer are stacked in this order,
the substrate film is composed of polyethylene terephthalate, and
the metal thin layer contains aluminum or copper.

20. The cable according to claim 2, wherein the metal tape is made of aluminum foil or copper foil.
